(19) United States
(12) Patent Application Publication
(10) Pub. No.: US 2020/0217967 A1
(43) Pub. Date: Jul. 9, 2020

(54) SYSTEMS AND METHODS FOR MODULATING THE RANGE OF A LIDAR SENSOR ON AN AIRCRAFT

(71) Applicant: A^3 by Airbus LLC, Sunnyvale, CA (US)

(72) Inventors: Arne Stoschek, Palo Alto, CA (US); Alex Naiman, Santa Clara, CA (US)

(73) Assignee: A^3 by Airbus LLC, Sunnyvale, CA (US)

(21) Appl. No.: 16/627,567

(22) PCT Filed: Jun. 30, 2017
(86) PCT No.: PCT/US17/40461

§ 371 Date: Dec. 30, 2019

(51) Int. Cl. G01S 17/933; G01S 7/484; G01S 7/486; G01S 17/89; G01S 17/10

(52) U.S. Cl. CPC G01S 17/933; G01S 7/484; G01S 17/10; G01S 17/89; G01S 7/4868

(57) ABSTRACT

A monitoring system (5) for an aircraft (10) can modulate the range of a LIDAR sensor (30) on the aircraft (10) by increasing or decreasing the power level of the LIDAR sensor (30) in response to particular conditions at the aircraft (10). When the aircraft (10) is operating in a takeoff or landing mode, the range of the LIDAR sensor (30) is reduced to avoid possible eye damage to surrounding people or animals. As the aircraft (10) transitions to a cruise mode, the range of the LIDAR sensor (30) can be increased since the expectation is that there are no people or animals in the vicinity of the aircraft. If the system (5) detects the presence of an object (15) near the aircraft (10) during operation in cruise mode, the system (5) can determine if there is an eye safety concern associated with the object (15) and reduce the range of the LIDAR sensor (30) in the area around the object (15).

### CROSS REFERENCE TO RELATED APPLICATION

This application claims priority to International Application PCT/US2017/040461, entitled “SYSTEMS AND METHODS FOR MODULATING THE RANGE OF A LIDAR SENSOR ON AN AIRCRAFT” and filed on Jun. 30, 2017, which is incorporated herein by reference.

### BACKGROUND

Aircraft may encounter a wide variety of collision risks during flight, such as debris, other aircraft, equipment, buildings, birds, terrain, and other objects. Collision with any such object may cause significant damage to an aircraft and, in some cases, injure its occupants. Sensors can be used to detect objects that pose a collision risk and warn a pilot of the detected collision risks. If an aircraft is self-piloted, sensor data indicative of objects around the aircraft may be used by a controller to avoid collision with the detected objects. In other examples, objects may be sensed and classified for assisting with navigation or control of the aircraft in other ways.

One type of sensor that can be used on an aircraft to detect objects is a LIDAR (light detection and ranging) sensor. The LIDAR sensor works by using a laser to send a laser beam or pulse at an object and calculating the distance from the measured time-of-flight and the intensity of the returning laser beam or pulse. The range for a LIDAR sensor can be defined by the sensitivity of the LIDAR sensor when collecting the returning laser beam or pulse. A range for a LIDAR sensor in applications involving use of the LIDAR sensor near the ground is typically limited to about 100-200 meters due to eye safety concerns related to operating the laser of the LIDAR sensor at a higher power. The relatively short range of a LIDAR sensor due to eye safety concerns can limit the usefulness of the LIDAR sensor in detecting objects in front of moving aircraft, which typically operate at high speeds.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure.

FIG. 1 depicts a three-dimensional perspective view of an aircraft having an aircraft monitoring system in accordance with some embodiments of the present disclosure.

FIG. 2 depicts a top perspective view of an aircraft, such as is depicted by FIG. 1, in accordance with some embodiments of the present disclosure.

FIG. 3 is a block diagram illustrating various components of an aircraft monitoring system in accordance with some embodiments of the present disclosure.

FIG. 4 is a block diagram illustrating a sense and avoid element in accordance with some embodiments of the present disclosure.

FIG. 5 is a flow chart illustrating a method for modulating a power level of a LIDAR sensor in accordance with some embodiments of the present disclosure.

FIG. 6 is a graph illustrating a relationship between aircraft altitude and the laser power of a LIDAR sensor in accordance with some embodiments of the present disclosure.

FIG. 7 is a block diagram illustrating a scan range from a LIDAR sensor on an aircraft in accordance with some embodiments of the present disclosure.

FIG. 8 is a graph illustrating a relationship between the laser power of a LIDAR sensor and a scan range angle, such as is depicted by FIG. 7, in accordance with some embodiments of the present disclosure.

FIG. 9 is a graph illustrating a relationship between the laser power of a LIDAR sensor and a detected obstacle over time in accordance with some embodiments of the present disclosure.

### DETAILED DESCRIPTION

The present disclosure generally pertains to vehicular systems and methods for modulating the range of a LIDAR sensor used by the vehicular system such as an aircraft. In some embodiments, an aircraft includes an aircraft monitoring system having sensors that are used to sense the presence of objects around the aircraft for collision avoidance, navigation, or other purposes. At least one of the sensors is a LIDAR sensor that can be modulated to increase the range of the LIDAR sensor (i.e., the distance at which the LIDAR sensor is able to detect objects). The range of the LIDAR sensor can be increased by increasing the power to the laser of the LIDAR sensor when the aircraft (and correspondingly the LIDAR sensor) is in a position where the increased power of the laser does not pose a risk of eye damage to humans or animals.

The increased range of the LIDAR sensor can be used when the aircraft is operating in a cruise mode (e.g., engaged in forward flight or moving in a horizontal direction) at a cruising elevation. When operating in cruise mode, if the aircraft detects an object within the beam scan or scan range of the LIDAR sensor, a determination is made as to whether there are eye safety concerns associated with the object. If there are eye safety concerns associated with the object (e.g., if the object is a bird, helicopter or building), the power level (and corresponding range) of the LIDAR sensor is reduced to avoid any risk of eye damage to a person or animal. The power level of the LIDAR sensor can be reduced for the portion of the scan range associated with the object (e.g., a safety range associated with the angular heading of the object). For the portions of the beam scan that are not associated with the object, the LIDAR sensor can remain at the increased range and power level. Once the object has moved from the scan range of the LIDAR sensor, the range and power level of the LIDAR sensor can be increased for the portion of the scan range that was at the reduced power level. If there is not any eye safety concerns associated with the object detected by the aircraft, the LIDAR sensor can continue to operate at the increased range and power level.

During takeoff and landing operations in hover flight, the LIDAR sensor of the aircraft can be operated at the reduced range and power level to prevent eye damage to any people or animals that may be in the vicinity of the takeoff/landing area or hover area for the aircraft. As the aircraft transitions from a takeoff operation in hover flight to a cruising operation, the range and power level of the LIDAR sensor can be increased since the possibility of eye damage to people or animals is not likely present at a cruising elevation where the presence of people or animals is not expected. Conversely, as the aircraft transitions from a cruising operation to a landing operation or hover flight, the range and power level of the LIDAR sensor are reduced to avoid the possibility of eye damage to people or animals since the aircraft is moving into an area where people or animals are expected to be present.

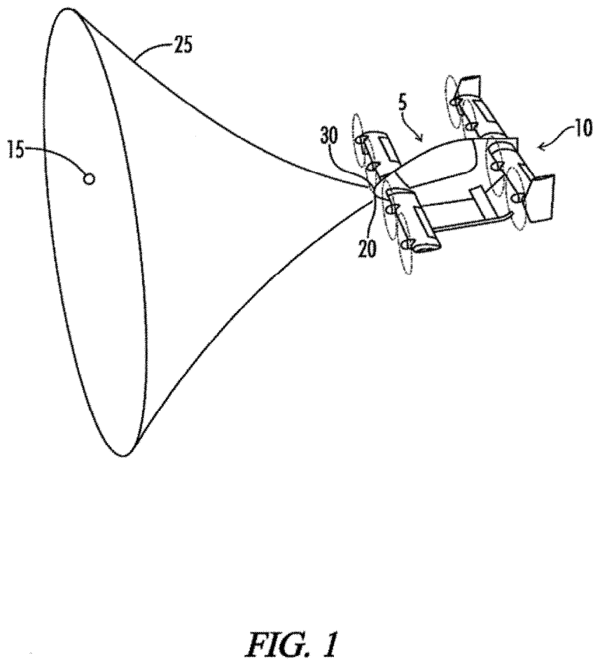

FIG. 1 depicts a three-dimensional perspective view of an aircraft 10 having an aircraft monitoring system 5 in accordance with some embodiments of the present disclosure. The system 5 is configured to use sensors 20, 30 to detect an object 15 that is within a certain vicinity of the aircraft 10, such as near a flight path of the aircraft 10.

Note that the object 15 can be of various types that aircraft 10 may encounter during flight. As an example, the object 15 may be another aircraft, such as a drone, airplane or helicopter. The object 15 also can be a bird, debris, or terrain that are close to a path of the aircraft 10. In some embodiments, object 15 can be various types of objects that may damage the aircraft 10 if the aircraft 10 and object 15 collide. In this regard, the aircraft monitoring system 5 is configured to sense any object 15 that poses a risk of collision and classify it as described herein.

The object 15 of FIG. 1 is depicted as a single object that has a specific size and shape, but it will be understood that object 15 may have various characteristics. In addition, although a single object 15 is depicted by FIG. 1, there may be any number of objects 15 within a vicinity of the aircraft 10 in other embodiments. The object 15 may be stationary, as when the object 15 is a building, but in some embodiments, the object 15 may be capable of motion. For example, the object 15 may be another aircraft in motion along a path that may pose a risk of collision with the aircraft 10. The object 15 may be other obstacles (e.g., terrain or buildings) posing a risk to safe operation of aircraft 10 in other embodiments.

The aircraft 10 may be of various types, but in the embodiment of FIG. 1, the aircraft 10 is depicted as an autonomous vertical takeoff and landing (VTOL) aircraft 10. The aircraft 10 may be configured for carrying various types of payloads (e.g., passengers, cargo, etc.). The aircraft 10 may be manned or unmanned, and may be configured to operate under control from various sources. In the embodiment of FIG. 1, the aircraft 10 is configured for self-piloted (e.g., autonomous) flight. As an example, aircraft 10 may be configured to perform autonomous flight by following a predetermined route to its destination. The aircraft monitoring system 5 is configured to communicate with a flight controller (not shown in FIG. 1) on the aircraft 10 to control the aircraft 10 as described herein. In other embodiments, the aircraft 10 may be configured to operate under remote control, such as by wireless (e.g., radio) communication with a remote pilot. Various other types of techniques and systems may be used to control the operation of the aircraft 10. Exemplary configurations of an aircraft are disclosed by PCT Application No. 2017/018135, which is incorporated herein by reference, and PCT Application No. 2017/040413, entitled “Vertical Takeoff and Landing Aircraft with Passive Wing Tilt” and filed on even date herewith, which is incorporated herein by reference. In other embodiments, other types of aircraft may be used.

Although the embodiments disclosed herein generally concern functionality attributed to aircraft monitoring system 5 as implemented in an aircraft, in other embodiments, systems having similar functionality may be used with other types of vehicles 10, such as automobiles or watercraft. As an example, it is possible for a boat or ship to increase the power level and range of a LIDAR sensor once it has moved a certain distance from shore or port.

In the embodiment of FIG. 1, the aircraft 10 has one or more sensors 20 (e.g., radar and/or cameras) for monitoring the space around aircraft 10, and one or more LIDAR (light detection and ranging) sensors 30 for providing redundant sensing of the same space or sensing of additional spaces. In some embodiments, each sensor 20, 30 may sense the presence of an object 15 within the sensor's respective field of view and provide sensor data indicative of a location of any object 15 within such field of view. Such sensor data may then be processed to determine whether the object 15 presents a collision threat to the vehicle 10. In one embodiment, the sensors 20 may include any optical or non-optical sensor for detecting the presence of objects, such as a camera, an electro-optical or infrared (EO/IR) sensor, a radio detection and ranging (radar) sensor, or other sensor type. Exemplary techniques for sensing objects using sensors 20, 30 are described in PCT Application No. PCT/US2017/25592 and PCT Application No. PCT/US2017/25520, each of which is incorporated by reference herein in its entirety.

When the aircraft 10 transitions from cruise mode into takeoff/landing mode, aircraft monitoring system 5 may process data from sensors 20, 30 that are configured and oriented in the direction of motion of the aircraft 10. In this regard, aircraft 10 and aircraft monitoring system 5 are configured to receive sensor data from sensors 20, 30 that are configured and oriented to sense in the space that is in the direction of motion of the aircraft 10. The aircraft monitoring system 5 may also receive sensor data from sensors 20, 30 that are configured and oriented to sense in other space so that the system 5 can detect an object 15 approaching the aircraft 10 from any direction.

FIG. 1 further shows an escape envelope 25 generated by the aircraft monitoring system 5 in response to detection of the object 15. The escape envelope 25 defines the boundaries of a region through which escape paths may be selected. The escape envelope may be based on various factors, such as the current operating conditions of the aircraft (e.g., airspeed, altitude, orientation (e.g., pitch, roll, or yaw), throttle settings, available battery power, known system failures, etc.), capabilities (e.g., maneuverability) of the aircraft under the current operating conditions, weather, restrictions on airspace, etc. Generally, the escape envelope 25 defines a range of paths that the aircraft is capable of flying under its current operating conditions. The escape envelope 25 generally widens at points further from the aircraft 10 indicative of the fact that the aircraft 10 is capable of turning farther from its present path as it travels. In the embodiment shown by FIG. 1, the escape envelope is in the shape of a funnel, but other shapes are possible, e.g., a conical shape, in other embodiments.

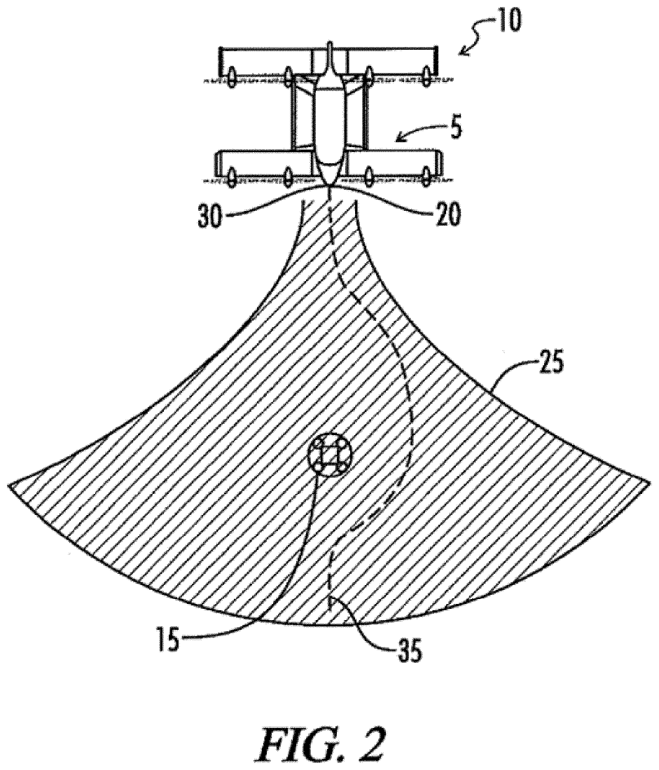

Moreover, when an object 15 is identified in data sensed by sensors 20, 30, the aircraft monitoring system 5 may use information about the aircraft 10 to determine an escape envelope 25 that represents a possible range of paths that aircraft 10 may safely follow (e.g., within a predefined margin of safety or otherwise). Based on the escape envelope 25, the system 5 then selects an escape path within the envelope 25 for the aircraft 10 to follow in order to avoid the detected object 15. In this regard, FIG. 2 depicts an exemplary escape path 35 identified and validated by the system 5. In identifying the escape path 35, the system 5 may use information from sensors 20, 30 about the sensed object 15, such as its location, velocity, and probable classification (e.g., that the object is a bird, aircraft, debris, building, etc.). Escape path 35 may also be defined such that the aircraft 10 will return to the approximate heading that the aircraft 10 was following before performing evasive maneuvers. Exemplary techniques for determining an escape envelope 25 and/or an escape path 35 are described in U.S. Patent Application No. 62/503,311, which is incorporated by reference herein in its entirety.

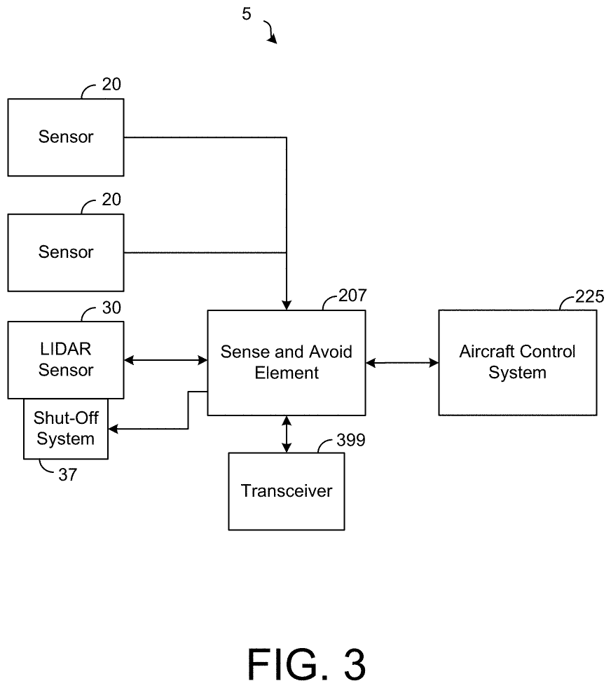

FIG. 3 is a block diagram illustrating various components of an aircraft monitoring system 5 in accordance with some embodiments of the present disclosure. As shown by FIG. 3, the aircraft monitoring system 5 may include a sense and avoid element 207, a plurality of sensors 20, 30, and an aircraft control system 225. Although particular functionality may be attributed to various components of the aircraft monitoring system 5, it will be understood that such functionality may be performed by one or more components of the system 5 in some embodiments. In addition, in some embodiments, components of the system 5 may reside on the aircraft 10 or otherwise, and may communicate with other components of the system 5 via various techniques, including wired (e.g., conductive), optical, or wireless communication. Further, the system 5 may include various components not specifically depicted in FIG. 3 for achieving the functionality described herein and generally performing threat-sensing operations and aircraft control.

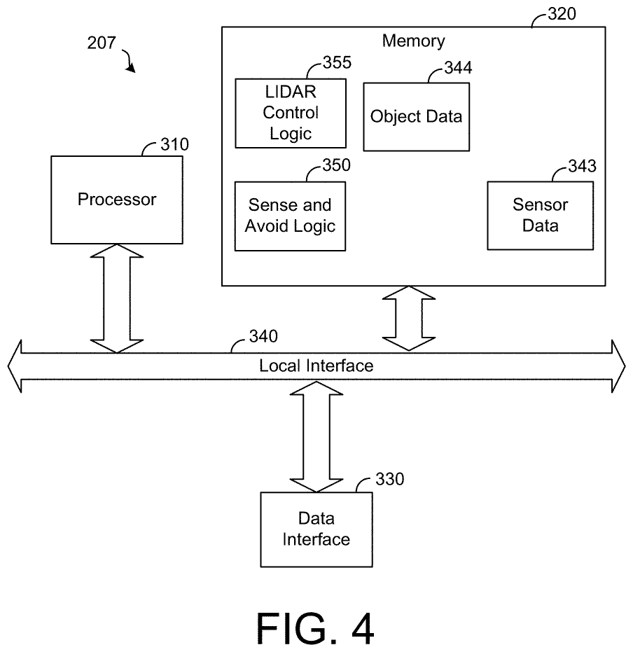

The sense and avoid element 207 of aircraft monitoring system 5 may perform processing of data received from sensors 20, 30 and aircraft control system 225 to modulate the range and power level of the LIDAR sensor 30. In addition, the sense and avoid element 207 can control a shut-off system 37 for each LIDAR sensor 30. The shut-off system 37 can be used to stop the transmission of a laser beam or pulse from a laser of the LIDAR sensor 37. The shut-off system 37 may incorporate mechanical devices (e.g., a shutter device) and/or electrical devices (e.g., a disconnect switch) to stop the transmission of the laser beam or pulse. In some embodiments, as shown by FIG. 3, the sense and avoid element 207 may be coupled to each sensor 20, 30, to process the sensor data from the sensors 20, 30, and provide signals to the aircraft control system 225. The sense and avoid element 207 may be various types of devices capable of receiving and processing sensor data from sensors 20, 30. The sense and avoid element 207 may be implemented in hardware or a combination of hardware and software/firmware. As an example, the sense and avoid element 207 may include one or more application-specific integrated circuits (ASICs), field-programmable gate arrays (FPGAs), microprocessors programmed with software or firmware, or other types of circuits for performing the described functionality. An exemplary configuration of the sense and avoid element 207 will be described in more detail below with reference to FIG. 4.

In some embodiments, the aircraft control system 225 may include various components (not specifically shown) for controlling the operation of the aircraft 10, including the velocity and route of the aircraft 10. As an example, the aircraft control system 25 may include thrust-generating devices (e.g., propellers), flight control surfaces (e.g., one or more ailerons, flaps, elevators, and rudders) and one or more controllers and motors for controlling such components. The aircraft control system 225 may also include sensors and other instruments for obtaining information about the operation of the aircraft components and flight.

FIG. 4 depicts a sense and avoid element 207 in accordance with some embodiments of the present disclosure. As shown by FIG. 4, the sense and avoid element 207 may include one or more processors 310, memory 320, a data interface 330 and a local interface 340. The processor 310 may be configured to execute instructions stored in memory 320 in order to perform various functions, such as processing of sensor data from the sensors 20, 30 (see FIGS. 1 and 2). The processor 310 may include a central processing unit (CPU), a digital signal processor (DSP), a graphics processing unit (GPU), an FPGA, other types of processing hardware, or any combination thereof. Further, the processor 310 may include any number of processing units to provide faster processing speeds and redundancy, as will be described in more detail below. The processor 310 may communicate to and drive the other elements within the sense and avoid element 207 via the local interface 340, which can include at least one bus. Further, the data interface 330 (e.g., ports or pins) may interface components of the sense and avoid element 207 with other components of the system 5, such as the sensors 20, 30.

As shown by FIG. 4, the sense and avoid element 207 may include sense and avoid logic 350 and LIDAR control logic 355, each of which may be implemented in hardware, software, firmware or any combination thereof. In FIG. 4, the sense and avoid logic 350 and LIDAR control logic 355 are implemented in software and stored in memory 320 for execution by the processor 310. However, other configurations of the sense and avoid logic 350 and LIDAR control logic 355 are possible in other embodiments.

Note that the sense and avoid logic 350 and LIDAR control logic 355, when implemented in software, can be stored and transported on any computer-readable medium for use by or in connection with an instruction execution apparatus that can fetch and execute instructions. In the context of this document, a “computer-readable medium” can be any means that can contain or store code for use by or in connection with the instruction execution apparatus.

The sense and avoid logic 350 is configured to receive data sensed by sensors 20, 30, classify an object 15 based on the data and assess whether there is a collision risk between object 15 and aircraft 10. Sense and avoid logic 350 is configured to identify a collision threat based on various information such as the object's location and velocity.

In some embodiments, the sense and avoid logic 350 is configured to classify the object 15 in order to better assess its possible flight performance, such as speed and maneuverability, and threat risk. In this regard, the sense and avoid element 207 may store object data 344 indicative of various types of objects, such as birds or other aircraft, that might be encountered by the aircraft 10 during flight. For each object type, the object data 344 defines a signature that can be compared to sensor data 343 to determine when a sensed object corresponds to the object type. As an example, the object 344 may indicate the expected size and shape for an object that can be compared to an object's actual size and shape to determine whether the object 15 matches the object type. It is possible to identify not just categories of objects (e.g., bird, drone, airplane, helicopter, etc.) but also specific object types within a category. As an example, it is possible to identify an object as a specific type of airplane (e.g., a Cessna 172). In some embodiments, the sense and avoid element 207 may employ a machine learning algorithm to classify object types. For each object type, the object data 344 defines information indicative of the object's performance capabilities and threat risk.

The sense and avoid logic 350 is configured to process sensor data 343 dynamically as new data becomes available. As an example, when sense and avoid element 207 receives new data from sensors 20, 30, the sense and avoid logic 350 processes the new data and updates any previously made determinations as may be desired. The sense and avoid logic 350 thus may update an object's location, velocity, threat envelope, etc. when it receives new information from sensors 20, 30. Thus, the sensor data 343 is repetitively updated as conditions change.

In an exemplary operation of aircraft monitoring system 5, each of the sensors 20, 30 may sense the object 15 and provide data that is indicative of the object's position and velocity to sense and avoid element 207, as described above. Sense and avoid element 207 (e.g., logic 350) may process the data from each sensor 20, 30 and may note discrepancies between information indicated by data from each sensor (e.g., based on sensor data 343 or otherwise). Sense and avoid logic 350 further may resolve discrepancies present within data from sensors 20, 30 based on various information such as calibration data for each sensor 20, 30 that may be stored as sensor data 343 or otherwise in other embodiments. In this regard, sense and avoid logic 350 may be configured to ensure that information about objects sensed by sensors 20, 30 of the aircraft 10 is accurate for use by the LIDAR control logic 355 in modulating the range and power level of the LIDAR sensor 30.

Note that, in some embodiments, sense and avoid logic 350 may be configured to use information from other aircraft 10 for detecting the presence or location of objects 15. For example, in some embodiments, the aircraft 10 may be one unit of a fleet of aircraft which may be similarly configured for detecting objects within a vicinity of the aircraft. Further, the aircraft may be configured to communicate with one another in order to share information about sensed objects. As an example, the sense and avoid element 207 may be coupled to a transceiver 399, as shown by FIG. 3, for communicating with other aircraft. When the sense and avoid element 207 senses an object 15, it may transmit information about the object 15, such as the object's type, location, velocity, performance characteristics, or other information, to other aircraft so that sense and avoid elements on the other aircraft can monitor and avoid the object 15. Further, the sense and avoid element 207 may receive similar information about objects 15 detected by other aircraft, and use such information to monitor and avoid such objects 15. In some embodiments, mediation between vehicles may occur via various types of protocols, such as ADS-B beacons. In some embodiments, the communication among the various aircraft may be facilitated through the use of communication with a central controller (not shown), referred to hereafter as “fleet controller,” that receives and processes information from multiple aircraft 10. Such fleet controller may be at any location, such as at a ground-based facility (e.g., an air traffic control tower) or other location. Information about detected objects may be transmitted to the fleet controller, which then assimilates the information from multiple aircraft 10 into a three-dimensional map of objects and distributes such map or other information to the aircraft 10 so that each aircraft 10 is aware of the location of objects detected by other aircraft. Yet other techniques for sharing information among aircraft 10 are possible in other embodiments.

The LIDAR control logic 355 can be used to modulate the range of the LIDAR sensor 30 by controlling the power level provided to a laser for the LIDAR sensor 30. The LIDAR control logic 355 can provide signals to the laser for the LIDAR sensor 30 to control the output power level from the laser. In one embodiment, the signals provided by the LIDAR control logic 355 to the laser for the LIDAR sensor 30 can be pulse width modulated signals. However, the LIDAR control logic 355 can provide other types of signals to the laser for the LIDAR sensor 30 in other embodiments. In addition, the LIDAR control logic 355 can continuously receive signals from the LIDAR sensor 30 indicating the current power level for the laser of the LIDAR sensor 30. The LIDAR control logic 355 can use the information regarding the current power level of the laser for the LIDAR sensor 30 when generating the signals to adjust the power level of the laser for the LIDAR sensor 30.

When the aircraft 10 is in an area where there may be people or animals susceptible to eye damage from the laser in the LIDAR sensor 30, such as when the aircraft is in a takeoff/landing mode (i.e., performing a takeoff or landing operation), the LIDAR control logic 355 can operate the laser in the LIDAR sensor 30 at an “eye safe” level that corresponds to a power level of the beams or pulses from the laser that is deemed safe for the eyes of a person or animal. In contrast, if the aircraft 10 is at a cruising elevation (i.e., a predefined distance above ground level (AGL) where people or animals are not expected to be located) and in a cruise mode (i.e., performing (or about to perform) a cruising operation for forward flight), the LIDAR control logic 355 can operate the laser in the LIDAR sensor 30 at an “extended range” level, such that the power level of the beams or pulses from the laser are able to detect objects at a greater distance from the LIDAR sensor 30 relative to the range available to the LIDAR sensor 30 when operated at the eye safe level. In one embodiment, the detection range of the LIDAR sensor 30 operating at the extended range level can be about 1000 meters. However, in other embodiments, the range of the LIDAR sensor 30 operating at the extended range level can be greater than or less than 1000 meters. The range of the LIDAR sensor 30 operating at the extended range level can be about 5 to 10 (or more) times greater than the range of the LIDAR sensor 30 operated at the eye safe level, which can be about 100-200 meters. The power level for the laser when operated at the extended range level can vary based on many different factors such as the size and configuration of the aircraft 10 and the velocity of the aircraft 10 during a cruising operation. For example, an aircraft 10 that is operated at a higher velocity during a cruising operation may require a larger range (and corresponding higher power level) from the LIDAR sensor 30 in order to detect objects 15 with sufficient time to avoid collisions relative to an aircraft 10 that is operated at a lower velocity.

During operation of the aircraft 10 in a cruising mode for forward flight, the sense and avoid logic 350 can determine if an object 15 is within the scan range (or sweep) of the LIDAR sensor 30. The scan range of the LIDAR sensor 30 corresponds to the angular displacement of a beam or pulse from the laser of the LIDAR sensor 30 between the beginning of a scan by the LIDAR sensor 30 and the end of a scan by the LIDAR sensor 30. In one embodiment, as shown in FIG. 7, the scan range for a LIDAR sensor 30 can be 90 degrees. However, in other embodiments, the scan range for the LIDAR sensor 30 can be greater than or less than 90 degrees.

After the sense and avoid logic 350 determines that there is an object 15 in the scan range for the LIDAR sensor 30, the LIDAR control logic 355 can determine whether the power level for the laser of the LIDAR sensor 30 should be adjusted from the extended range level due to eye safety concerns associated with the object 15. The LIDAR control logic 355 can make the determination on whether the object 15 has an associated eye safety concern based on object identification information, distance information (i.e., the distance between the LIDAR sensor 30 and the object 15) and environment information provided to the LIDAR control logic 355 by the sense and avoid logic 350. If the object 15 raises eye safety concerns, such as when the object 15 is an animal (e.g., a goose) or contains one or more people (e.g., a building or helicopter) and is at a distance from the LIDAR sensor 30 where the increased power level of the beam or pulse from the laser for the LIDAR sensor 30 may be unsafe and cause eye damage to a person or animal, the LIDAR control logic 355 reduces the power level of the laser for the LIDAR sensor 30 from the extended range level. For example, the LIDAR control logic 355 can modulate or limit the power of the LIDAR sensor 30 based on the proximity of the aircraft 10 to a known static object, such as a building. The LIDAR control logic 355 can know the location of the building from 3D map information provided to (or generated by) the LIDAR control logic 355. The LIDAR control logic 355 can then determine the position of the aircraft 10 in the 3D map and calculate the distance and/or direction of the aircraft 10 relative to the building. The LIDAR control logic 355 can then use the distance and/or direction information to adjust the power to the LIDAR sensor 30.

The LIDAR control logic 355 can reduce the power level for the laser of the LIDAR sensor 30 to either the eye safety level or an intermediate level between the eye safety level and the extended range level. In one embodiment, the intermediate level is based on a distance of the aircraft 10 from the object 15. In another embodiment, the intermediate level can correspond to a power level that does not raise eye safety concerns at the location of the object. In other words, the power level of the beam or pulse transmitted by the laser is reduced by a sufficient amount such that when the beam or pulse reaches the object, the beam or pulse has dissipated enough energy such that the beam or pulse does not raise eye safety concerns to a person or animal. In still other embodiments, the intermediate level can be based on the type of object (e.g., an animal and human may have different intermediate levels) or on the velocity of the object (e.g., faster moving objects and slower moving objects may have different intermediate levels). If the object 15 does not raise eye safety concerns, such as when the object is part of the terrain (e.g., a mountain) or a drone, the LIDAR control logic 355 can continue to keep the power level for the laser of the LIDAR sensor 30 at the extended range level.

When the LIDAR control logic 355 determines that the power level for the laser of the LIDAR sensor 30 is to be reduced, the LIDAR control logic 355 may reduce the power level for only a portion of the scan range that corresponds to an area or zone in which the object 15 is located. The LIDAR control logic 355 can determine the location or position of the object 15 relative to the LIDAR sensor 30 using information from sensors 20, 30 and the sense and avoid logic 350. Once the position of the object 15 is known, the LIDAR control logic 355 can operate the laser of the LIDAR sensor 30 at a reduced power level, as discussed above, for the portion of the scan range corresponding to the object. In one embodiment, the LIDAR control logic 355 operates the laser at a reduced power in the direction of the object 15 plus an angular offset to provide a desired margin of error. In one embodiment, the angular offset can be about ±10 degrees, but other offsets are possible in other embodiments. The LIDAR control logic 355 can operate the remainder of the scan range for the LIDAR sensor 30 at the extended range level. By reducing the power level of the LIDAR sensor 30 in the area or zone of an object with eye safety concerns, while maintaining the extended range power level for the remainder of the scan range, the LIDAR sensor 30 is able to continue receive information at an extended range without introducing an eye safety concern to people or animals associated with the object 15. Once the object 15 has moved from the scan range of the LIDAR sensor 30, the LIDAR control logic 355 can operate the laser for the LIDAR sensor 30 at the extended range level for the entire scan range of the LIDAR sensor unless a new object 15 with eye safety concerns has been detected. In one embodiment, if multiple objects 15 with eye safety concerns have been detected within the scan range of the LIDAR sensor 30, the LIDAR control logic 355 can reduce the power level for each of the objects 15 in the scan range, as described above.

As the aircraft 10 transitions from cruise mode to takeoff/landing mode, such as when the aircraft 10 has reached the end of a flight path and is preparing to land, the LIDAR control logic 355 can modulate the power level for the laser of the LIDAR sensor 30 from the extended range level back to the eye safe level. In one embodiment, if the aircraft 10 is a VTOL aircraft that has a hover mode (i.e., the aircraft 10 maintains a predefined position and elevation), the LIDAR control logic 355 can provide different power levels for the LIDAR sensor 30 for different types of scans. For example, a vertical scan from the LIDAR sensor may be at the eye safe level, while a horizontal scan from the LIDAR sensor 30 may be at the extended range level depending on the elevation of the aircraft 10 and the environment surrounding the aircraft 10.

The LIDAR control logic 355 is configured to process data dynamically as new data becomes available from the sense and avoid logic 350 when the aircraft 10 is operating in cruise mode. For example, the LIDAR control logic 355 can receive new data from the sense and avoid logic 350 indicating that an object 15 having eye safety concerns has either exited the scan range for the LIDAR sensor 30 or changed position relative to the LIDAR sensor 30. If the object 15 has exited the scan range, the LIDAR control logic 355 can operate the laser for the LIDAR sensor 30 at the extended range level. If the object 15 has moved closer to the LIDAR sensor 30, the LIDAR control logic 355 can lower the power level to the laser for the LIDAR sensor 30 (if not already at the eye safe level) and if the object 15 has moved away from the LIDAR sensor 30, the LIDAR control logic 355 can increase the power level to the laser for the LIDAR sensor 30 that can still address eye safety concerns.

In one embodiment, if the LIDAR control logic 355 determines that the beam or pulse from the laser for the LIDAR sensor 30 poses an immediate eye safety concern, the LIDAR control logic 355 can send a signal to the shut-off system 37 to prevent or stop the laser for the LIDAR sensor 30 from transmitting a beam or pulse. As an example, if the LIDAR control logic 355 initially detects an object susceptible to eye damage in close proximity to the LIDAR sensor 30 (e.g., less than a threshold distance away), the LIDAR control logic 355 may completely shut off the laser rather than just reduce its power. In one embodiment, the shut-off system 37 can incorporate a shutter device or cover that can be closed to prevent the laser for the LIDAR sensor 30 from transmitting a beam or pulse. In another embodiment, the shut-off system 37 can incorporate a disconnect switch that can remove power from the laser for the LIDAR sensor 30 and prevent any transmission of a beam or pulse from the laser. In still other embodiments, other mechanical or electrical devices can be used to prevent transmission of a pulse or beam by the laser for the LIDAR sensor 30. The LIDAR control logic 355 can then send a subsequent signal to the shut-off system 37 to return to an operational state that permits the laser for the LIDAR sensor 30 to transmit a beam or pulse.

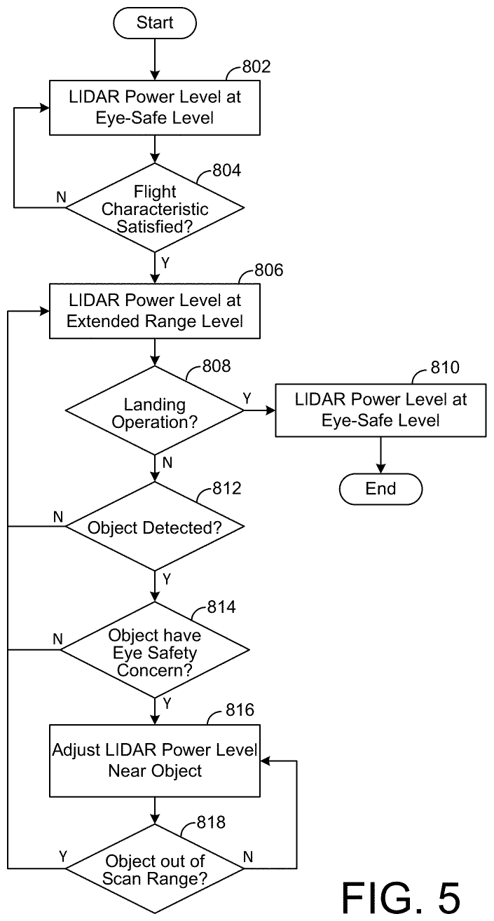

An exemplary use and operation of the system 5 in order to modulate the range and power level of a LIDAR sensor 30 of the aircraft 10 will be described in more detail below with reference to FIG. 5. For illustrative purposes, it will be assumed that the aircraft 10 is located on the ground and about to initiate a takeoff operation.

At step 802, the LIDAR control logic 355 can operate the LIDAR sensor 30 at the eye safe level since the aircraft 10 is either located on the ground or initiating a takeoff operation. A determination is then made as to whether the aircraft 10 has satisfied a predefined flight characteristic (e.g., reached a predetermined phase of flight) associated with the aircraft 10 at step 804. The predefined flight characteristic may correspond to a measurement of altitude, a transition to a particular flight configuration (e.g., a configuration for hover flight or forward flight), or a location of the aircraft. Further, reaching a predetermined phase of flight can be one or more of the aircraft 10 reaching a predefined altitude or entering a new altitude range, the aircraft transitioning to a new flight configuration (e.g., transitioning between a configuration for hover flight and forward flight), or the aircraft reaching a predefined location along a flight plan (e.g., entering or arriving at a less populated area or an urban area). As an example, once the aircraft 10 reaches a certain altitude (e.g., cruise altitude), transitions to a configuration for forward flight, or leaves an urban area to a sparsely populated area, it can be assumed that the risk of eye injury has sufficiently diminished such that the transmit power of the LIDAR sensor may be increased, as will be described below.

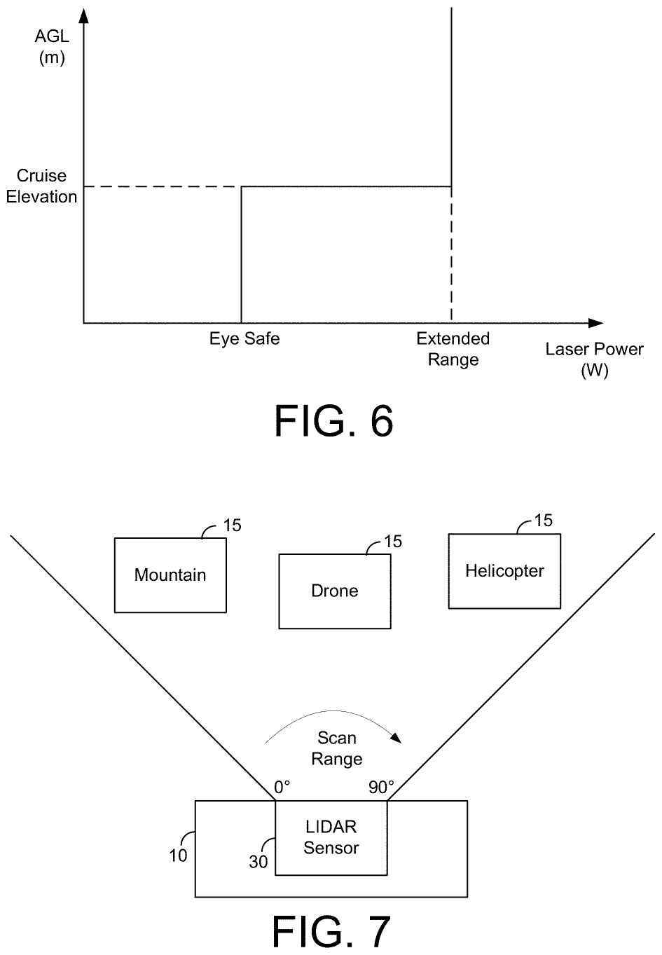

Referring to step 804, if the aircraft 10 has not satisfied the flight characteristic, the process returns to step 802 and the LIDAR control logic 355 can continue to operate the LIDAR sensor 30 at the eye safe level. However, if the aircraft 10 has satisfied the flight characteristic, the LIDAR control logic 355 can operate the LIDAR sensor 30 at the extended range level in step 806. As shown in FIG. 6, the LIDAR sensor 30 can be operated at the eye safe level while the aircraft 10 is ascending to the cruise elevation. Once the aircraft 10 reaches the cruise elevation, the LIDAR control logic 355 can increase the power level of the LIDAR sensor 30 to the extended range level.

Next, at step 808, a determination is made as to whether the aircraft 10 is initiating a landing operation. If the aircraft 10 is initiating a landing operation, the LIDAR control logic 355 can operate the LIDAR sensor 30 at the eye safe level at step 810 since there is an expectation that people or animals are within the scan range of the LIDAR sensor 30 and the process can end. If the aircraft 10 is not performing a landing operation at step 808, a determination can be made as to whether the aircraft 10 has detected an object 15 within the scan range of the LIDAR sensor 30 at step 812. The sense and avoid logic 350 can receive signals from sensors 20, 30 to make a determination as to whether there is an object 15 within the scan range of the LIDAR sensor 30. If the sense and avoid logic 350 has not detected an object 15 in the scan range of the LIDAR sensor 30, the process returns to step 806 and the LIDAR control logic 355 can continue to operate the LIDAR sensor 30 at the extended range level. However, if the sense and avoid logic 350 has detected an object 15 in the scan range of the LIDAR sensor 30, the LIDAR control logic 355 can then determine if the object 15 poses an eye safety concern at step 814. As discussed above, if the object 15 is associated with a person or animal and is at a sufficiently close distance to the LIDAR sensor 30, then the object 15 has as eye safety concern.

If the LIDAR control logic 355 determines that the object 15 does not have an eye safety concern, the process returns to step 806 and the LIDAR control logic 355 can continue to operate the LIDAR sensor 30 at the extended range level. However, if the LIDAR control logic 355 determines that the object 15 does have an eye safety concern, the LIDAR control logic 355 can reduce the power level of the LIDAR sensor 30 near the object 15 at step 816. As discussed above, the portion of the scan range of the LIDAR sensor 30 that is associated with the object 15 having eye safety concerns can be operated at a reduced power level that corresponds to either the eye safe level or an intermediate level that does not pose a risk of eye damage to the person or animal associated with the object 15 at the corresponding distance between the object 15 and LIDAR sensor 30.

After the LIDAR control logic 355 adjusts the power level of the LIDAR sensor 30 near the object 15, the LIDAR control logic 355 determines whether the object has exited the scan range for the LIDAR sensor 30 at step 818. The LIDAR control logic 355 can determine if the object 15 has exited the scan range for the LIDAR sensor 30 by receiving updated information from the sense and avoid logic 350 that indicates the object 15 has exited the scan range. An object 15 can exit the scan range for the LIDAR sensor 30 by travelling in a direction or elevation away from the scan range of the LIDAR sensor or by having the aircraft 10 alter its flight path or elevation as part of a collision avoidance algorithm. If the object 15 has not exited the scan range for the LIDAR sensor 30, the process returns to step 816 and the LIDAR control logic 355 can continue to operate the LIDAR sensor 30 at the reduced power level for the corresponding portion of the scan range as discussed above. However, if the object 15 has exited the scan range for the LIDAR sensor 30, the process returns to step 806 and the LIDAR control logic 355 can operate the LIDAR sensor 30 at the extended range level.

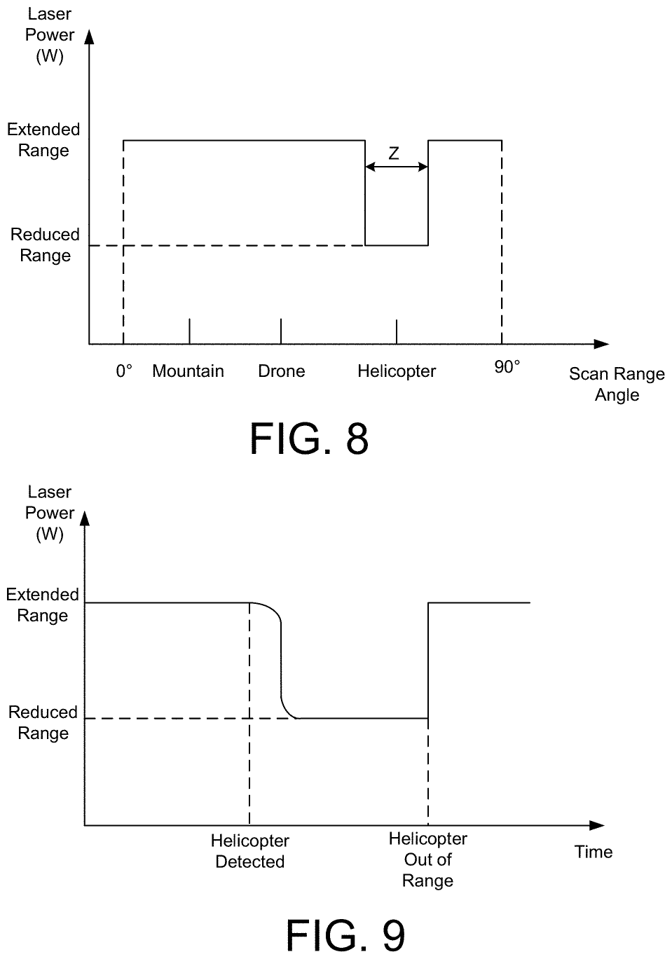

In one exemplary embodiment as shown in FIG. 7, three objects 15 (a mountain, a drone and a helicopter) can be detected within the scan range for the LIDAR sensor 30. As previously discussed, the LIDAR control logic 355 can evaluate each of the objects 15 and determine whether there are any eye safety concerns associated with each of the objects 15. Since the helicopter has an expectation of a person being located with it, the LIDAR control logic 355 identifies the helicopter as having an eye safety concern and identifies the drone and mountain as not having any eye safety concerns. In response to the determination by the LIDAR control logic 355 regarding the helicopter, the LIDAR control logic 355 adjusts the power level for the LIDAR sensor 30 in the area around the helicopter from the extended range level to a reduced range level as shown in FIG. 8. Depending on the distance between the LIDAR sensor 30 and the helicopter, the reduced range level may be either the eye safe level or an intermediate level. Further, the LIDAR control logic 355 can operate the LIDAR sensor 30 at the reduced range for a zone Z around the location of the helicopter as also shown in FIG. 8. The zone Z includes the angular offsets around the location of the helicopter to ensure that a beam or pulse from the LIDAR sensor 30 does not contact a person in the helicopter. FIG. 9 shows the time period for which the LIDAR control logic 355 provides the reduced range level for the LIDAR sensor 30 as a result of the detection of the helicopter until the helicopter leaves the scan range of the LIDAR sensor 30.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

1. A method for modulating a range of a light detection and ranging (LIDAR) sensor on an aircraft comprising:
sensing objects external to the aircraft with at least the LIDAR sensor;
determining a dynamic flight characteristic associated with the aircraft;
changing a transmission power of the LIDAR sensor during flight of the aircraft based on the dynamic flight characteristic, thereby changing the range of the LIDAR sensor; and
controlling a velocity the aircraft based on the sensed objects.

2. The method of claim Error! Bookmark not defined., wherein the dynamic flight characteristic is at least one from the group including: an altitude of the aircraft, a flight configuration of the aircraft, and a location of the aircraft.

3. The method of claim Error! Bookmark not defined., wherein the sensing comprises sensing at least one of the objects while the aircraft is in hover flight, and wherein the changing is performed when the aircraft is in or transitioning to forward flight.

4. A method for modulating a range of a light detection and ranging (LIDAR) sensor on an aircraft comprising:
operating a LIDAR sensor on an aircraft at a first power level to obtain a first detection range for the LIDAR sensor;
determining if the aircraft has transitioned to a predetermined phase of flight;
operating the LIDAR sensor on the aircraft at a second power level to obtain a second detection range for the LIDAR sensor in response to a determination that the aircraft has reached the predetermined phase of flight, wherein the second power level is greater than the first power level and the second detection range is greater than the first detection range;
detecting an object external to the aircraft based on the LIDAR sensor; and
controlling a velocity of the aircraft based on the detecting.

5. The method of claim 4, further comprising:
evaluating the detected object to determine information about the detected object; and
operating the LIDAR sensor on the aircraft at a third power level to obtain a third detection range for the LIDAR sensor in response to the evaluation of the detected object, wherein the third power level is less than the second power level and the third detection range is less than the second detection range.

6. The method of claim 5, wherein the evaluating the detected object includes identifying an object type for the detected object.

7. The method of claim 6, wherein the operating the LIDAR sensor on the aircraft at the third power level is based on the object type.

8. The method of claim 5, wherein operating the LIDAR sensor on the aircraft at the third power level includes operating the LIDAR sensor on the aircraft at the third power level for a portion of the scan range of the LIDAR sensor.

9. The method of claim 8, wherein the portion of the scan range of the LIDAR sensor corresponds to a zone around the detected object.

10. The method of claim 9, wherein:
the evaluating the detected object includes determining a location for the detected object relative to the scan range of the LIDAR sensor; and
the zone around the detected object includes the location of the detected object and an angular offset amount on each side of the location of the detected object.

11. The method of claim 5, wherein the third power level is one of the first power level or an intermediate power level.

12. The method of claim 11, wherein:
the evaluating the detected object includes determining a distance between the detected object and the LIDAR sensor; and
the intermediate power level is based on the determined distance.

13. The method of claim 4, wherein operation of the LIDAR sensor at the first power level is safe to an eye of a person and operation of the LIDAR sensor at the second power level is unsafe to an eye of a person.

14. The method of claim 4, further comprising stopping operation of the LIDAR sensor with a shut-off system.

15. A system, comprising:
a light detection and ranging (LIDAR) sensor for sensing objects external to an aircraft, the LIDAR sensor configured to operate at a first power level to obtain a first detection range for the LIDAR sensor and a second power level to obtain a second detection range for the LIDAR sensor, wherein the second power level is greater than the first power level and the second detection range is greater than the first detection range; and
a sense and avoid element having at least one processor configured to receive first data indicative of at least one object sensed by the LIDAR sensor and second data indicative of a transition to a predetermined phase of flight by the aircraft, the at least one processor of the sense and avoid element configured to determine if the aircraft has transitioned to the predetermined phase of flight based the second data, operate the LIDAR sensor on the aircraft at the first power level in response to a determination that the aircraft has not transitioned to a predetermined phase of flight, and operate the LIDAR sensor on the aircraft at the second power level in response to a determination that the aircraft has transitioned to the predetermined phase of flight, and
the at least one processor of the sense and avoid element further configured to detect an object based on the first data and operate the LIDAR sensor in response to detected object.

16. The system of claim 15, wherein the LIDAR sensor is further configured to operate at a third power level to obtain a third detection range for the LIDAR sensor, the third power level is less than the second power level, and the third detection range is less than the second detection range, the at least one processor of the sense and avoid element is further configured to evaluate the detected object to determine information about the detected object and operate the LIDAR sensor in the aircraft at the third power level in response to the evaluation of the detected object.

17. The system of claim 16, wherein the at least one processor of the sense and avoid element is further configured to identify an object type for the detected object.

18. The system of claim 17, wherein the at least one processor of the sense and avoid element is further configured to operate the LIDAR sensor on the aircraft at the third power level in response to the object type.

19. The system of claim 15, wherein the at least one processor of the sense and avoid element is further configured to operate the LIDAR sensor at the third power level for a portion of the scan range of the LIDAR sensor.

20. The system of claim 19, wherein the portion of the scan range of the LIDAR sensor corresponds to a zone around the detected object.

21. The system of claim 20, wherein the at least one processor of the sense and avoid element is further configured to determine a location for the detected object relative to the scan range of the LIDAR sensor, and the zone around the detected object includes the location of the detected object and an angular offset amount on each side of the location of the detected object.

22. The system of claim 15, wherein the at least one processor of the sense and avoid element is further configured to determine a distance between the detected object and the LIDAR sensor based on the first data, and the third power level is one of the first power level or an intermediate power level based on the determined distance.

23. The system of claim 15, further comprising a shut-off system configured to stop operation of the LIDAR sensor.

24. A system, comprising:
a light detection and ranging (LIDAR) sensor positioned on an aircraft for sensing objects external to the aircraft;
at least one processor configured to determine a dynamic flight characteristic associated with the aircraft and to change a transmission power of the LIDAR sensor during flight of the aircraft based on the dynamic characteristic, thereby changing a range of the LIDAR sensor, the at least one processor further configured to control a velocity of the aircraft based on the sensed objects.

25. The system of claim 24, wherein the dynamic flight characteristic is selected from at least one of the group including: an altitude of the aircraft, a flight configuration of the aircraft, and a location of the aircraft.

26. The system of claim 24, the dynamic flight characteristic is a location of the aircraft, and wherein the at least one processor is configured to determine a location of a static object based on a map and change the transmission power based on the location of the static object relative to the location of the aircraft.
